(19) United States
(12) Patent Application Publication
(10) Pub. No.: US 2006/0047669 A1
(43) Pub. Date: Mar. 2, 2006

(54) System and method for document and electronic file management

(76) Inventors: Hugh D. Durrence, Charleston, SC (US); Amy Elizabeth Alexander, Charleston, SC (US)

Correspondence Address: B. Craig Killough;Barnwell Whaley Patterson & Helms, LLC, P.O. Drawer H, Charleston, SC, 29402, US

(21) Appl. No.: 11/213,244

(22) Filed: Aug. 26, 2005

Related U.S. Application Data
(60) Provisional application No. 60/604,640, filed on Aug. 26, 2004.

(51) Int. Cl. G06F 17/30

(52) U.S. Cl. 707/10

(57) ABSTRACT

A system is presented that keeps and manages many varieties of information, and the metadata surrounding that information, in an electronic format. The system allows each organization to define for itself not only the types of information to be stored, but who will store and retrieve it, who will manage it, what will be done to protect it, and what metadata should be recorded for each of type of information owned by the organization.

Applicants claim the benefit of U.S. Provisional Application Ser. No. 60/604,640 filed Aug. 26, 2004

### FIELD OF THE INVENTION

The present invention relates to electronic file management, and is more particularly directed to a method of converting paper documents into electronic format and integrating electronic file formats into a central repository where they may be accessed by personnel and other software applications.

### BACKGROUND OF THE INVENTION

Modern organizations gather all sorts of information. This information is quite varied in terms of content and meaning—reports, internally generated documents, bills, spreadsheets, questionnaires, memoranda, directives, statements of policy, customer communications, and so on—and exists in a wide variety of both physical and electronic formats—such as facsimile (FAX), electronic mail, database records, paper or electronic pictures, and a nearly endless variety of electronic data formats. In most cases, the format of the information determines how that information is to be stored and managed—for example, pictorial information on paper or film is ordinarily stored and managed using a physical filing system; electronic mail messages are stored and managed using electronic mail servers and specialized client programs; discrete electronic documents are stored in electronic file systems based upon the operating system at hand; and so on. Not only must these discrete pieces of information themselves be stored; also, it is usually necessary to store and manage metadata surrounding discrete pieces of information (such as when the information was created/sent, who originated it, who is responsible for it, the subject to which it pertains, and so on).

The practical result of these realities is a disjointed information environment, in which various types of information are stored in separate places using different systems (paper filing systems, electronic mail systems, specialized applications, etc.), metadata about the information becomes separated from the information resource to which it pertains, and it is increasingly difficult for members of an organization to store, describe, locate, retrieve, and fully understand individual pieces of information belonging to the organization, as the amount and variety of the information increases.

### SUMMARY OF THE INVENTION

The present invention introduces a method and a system that keeps and manage many varieties of information, and the metadata surrounding that information, in an electronic format. The system allows each organization to define for itself not only the types of information to be stored, but who will store and retrieve it, who will manage it, what will be done to protect it, and what metadata should be recorded for each of type of information owned by the organization. Efficiency and accuracy of information storage and retrieval is enhanced by having a central repository to store multiple types of information so that the information is accessible by individuals and the diverse computer applications that comprise today's workplace, both within and outside the boundaries of the organization.

### DESCRIPTION OF THE DRAWINGS

FIG. 1 is a schematic of the system architecture.

FIG. 2 is a schematic showing an example of information processing according to the invention.

FIG. 3 is an example of a document as viewed by a user of the invention.

FIG. 4 shows a warning and a prompt from the invention.

### DESCRIPTION OF THE PREFERRED EMBODIMENTS

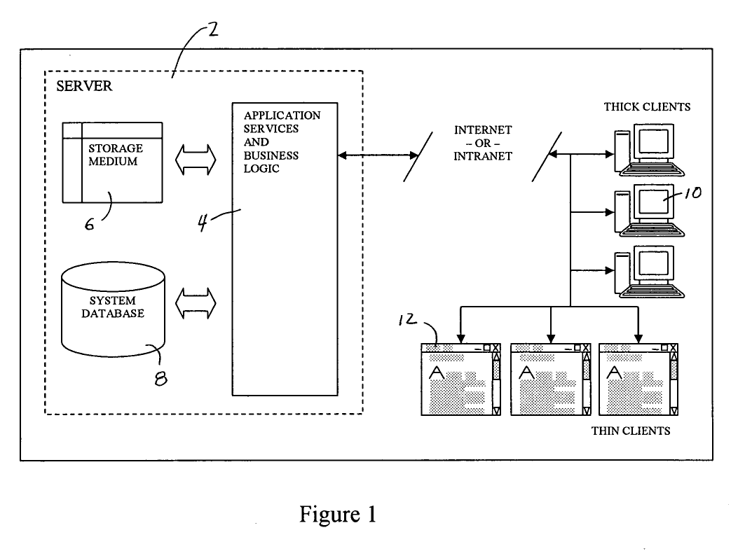

The system uses a server. FIG. 1. The server 2 is comprised of an application services and business logic layer 4, a storage medium 6, and the system database 8.

The application services and business logic layer exposes system functions through open standards—based mechanisms, such as eXtensible Markup Language (XML) Web Services, allowing the exchange of system data with third-party systems that implement these open standards. It also enforces security settings for the system. The storage medium stores all data files managed by the system. The system database maintains all metadata about information stored by the system, as well as the system itself.

Each layer of the server is implemented in such a way as to allow remote hosting (may or may not be located on the same physical computer), enabling both redundancy and load-sharing capabilities to enhance availability and system performance.

System clients may be thick clients 10 (compiled applications written by the system developer or third parties), thin clients 12 (allowing the use of the system through a web browser), or some combination thereof. System clients may also comprise a programmatic interface between this system and a third-party system, enabling sharing and utilization of system information outside of the application boundary.

Clients communicate with the server via the Internet or an organizational intranet, utilizing standard protocols, such as Internet Protocol (IP) and Hypertext Transfer Protocol (HTTP). Channel security may be provided, at the system administrator's option, through use of Secure Sockets Layer (SSL) to encrypt all data in transit.

The functions of an embodiment of the system may be summarized into the following phases of system operation: system definition; information processing; delivery of information; archival operations; activity reporting; system maintenance; and, cooperative information quality control. Each of these operational phases is characterized below

The System Definition phase comprises the steps of defining entities (users, subjects, and objects), defining information templates, and setting security constraints.

An entity is a person (or, in some cases, a third-party application utilizing the system with a specified set of credentials). An entity may be a user (one capable of interacting directly with the system, such as logging on to perform other functions), a subject (the person to whom specific information applies, such as a patient in a medical practice, a client of a law firm, or a customer of a business), an object (the person who is primarily responsible for specific items of information, such as a doctor treating a patient, a lawyer providing services to a client of a law firm, or a technical support representative assisting a customer), or any combination thereof. For example, in the case of a medical practice, the same entity may be a system user (someone who can log in), a subject (a patient of the practice), and an object (a medical provider at the practice) simultaneously.

The system features a well-formed and extensible set of privileges, each defining the right to perform a given operation. In the case of users, the definition includes the assignment of privileges to allow or constrain what the user can do within the system. The server verifies a user's privileges as required before carrying out any restricted operation on that user's behalf.

The system also features a capability for each using organization to define a set of meta-information to be recorded for instances of entities. It is important for each organization to be able to define its own needs for meta-information about entities. For example, in a medical practice, it may be important to record a patient's date of birth, whereas in a law firm, a client's date of birth may be superfluous. Part of this phase of operation is the definition of meta-information to be available to be stored for each type of entity, as well as designation of certain pieces of meta-information, at the using organization's option, to be required for a given type of entity (i.e., a medical practice may regard date of birth as a required field for patients, and may also choose to define other information, such as hobbies and interests, as optional).

The definition of each type of entity may require a separate privilege; thus, in an embodiment, three core privileges exist—the ability to define users, to define subjects, and to define objects. A fourth privilege may also exist, which must be held in order to define meta-information about entities in general.

Entities may be created through a single, discrete operation with a purpose-built interface (e.g., an interface exists that allows the creation of users, subjects, and objects one-by-one). Additionally, subjects and objects may be created through a batch operation (by means of parsing a comma-delimited text file describing each entity to be created, or through direct programmatic interface between a third-party system and the Application Services and Business Logic layer of the server).

One part of System Definition is the creation and management of Information Templates. An Information Template provides a framework for describing a given type of information resource—such as an X-Ray in a doctor's office, or a pleading or motion in a law firm.

Each Information Template may have a descriptive name, and a set of meta-information about that type of information. For example, an Information Template may be created by a technical support organization to encapsulate a support incident; such a template might be called “Support Ticket,” and might define meta-information such as the affected component or part and the basic nature of the problem.

Each document or information resource entered into the system may have a title; an Information Template may pre-define a list of titles to be selected by the user. For each pre-defined title, a more specific subset of meta-information may also be specified to be recorded when a document or information resource of the given type, with the given title, is entered. For example, a medical practice may define an Information Template called “Labs”—which, itself, could specify the name of the submitting laboratory as a piece of required meta-information. The type “Labs” could then contain a number of pre-defined titles—such as “Bone Marrow Density Study” and “EKG”—and, the selection or entry of a document with one of these titles could enable or force the recording of additional medical information specific to that kind of test when such a document is entered into the system.

The employment of Information Templates allows each system to be customized to the needs of the user base at hand, enhances the quality of information available within the system, and enforces standard information management practices throughout the using organization.

As previously described, a system user is a type of entity that can provide credentials to log in to the system and perform one or more operations. Typically, a set of privileges is defined, which limits the set of operations a particular user can perform.

Different organizations have different security needs. A doctor's office must strive to protect the confidentiality of patient data through every available means in order to comply with provisions of law and medical ethics; whereas a technical support organization may not be faced with such stringent requirements to protect customer data or technical data stored by the same system.

To accommodate differing security needs, the system is widely configurable in the way security settings are applied and enforced across the system. The system may be configured to require the use of SSL to encrypt HTTP data transfers; users can be forced to change passwords at a set maximum interval; passwords can be required to be more or less complex; and, interactive user sessions can be ‘timed-out’—forcing the user to re-authenticate at a given interval of inactivity.

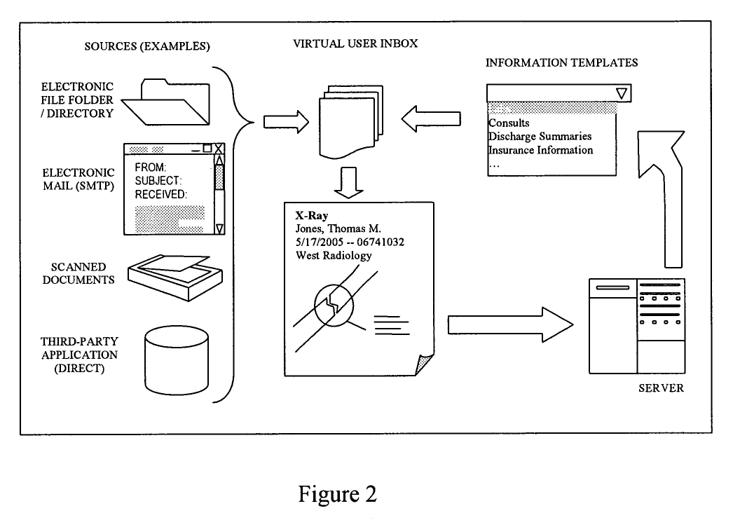

Information Processing is the act of consuming information from various sources, both electronic and physical (paper), into the system to be stored and managed. FIG. 2.

Each user has a set of information sources—such as a directory on a network share where the user can receive files, an electronic mail inbox, a location where scanned documents are kept, and/or an interface to a third-party application that publishes information to be consumed (for example, an application that routes FAX documents electronically). Also, before information can be processed into the system, an administrator creates one or more information templates as previously described (defining what meta-information is to be kept for each type of resource), and creates subjects and objects in the system as previously described.

The logical conjunction as described in this embodiment—information sources, information templates, subjects, and objects—forms a virtual user inbox. The user is presented with new information from various sources to be processed in this virtual inbox.

At this point, the user examines the piece of information to determine the subject (to whom or what entity the information applies), the object (what entity within the organization is directly involved with this piece of information), and the relevant information template (what type of information this represents), and records this information. Depending on the choices made by the administrator in setting up the information template, the user may also record other meta-information, and may be compelled to do so. The example in Error! Reference source not found. depicts a user processing an X-Ray, selecting the relevant subject (patient), object (medical provider), and other details as required by the information template (the name of the sending laboratory). This meta-information is combined with the original information resource (the actual X-Ray) to form a single, self-describing record, and is then transferred to the server for storage and later use.

Capabilities may be provided to directly edit certain types of information during processing—for example, electronic facsimile images can be rotated, cleaned up, split into different files, annotated, and combined with other image files. In cases where the system does not support directly editing an information resource in a given format, the default tool used by the operating system for editing files of the given format may be used if any editing is required.

Users may receive items in the virtual inbox that require no processing. Such items may be deleted directly by the system. Physical files may also be renamed at the user's discretion.

Also, in some cases, users may not be available to perform processing against the virtual inbox (for example, an employee goes on vacation or becomes ill). In such cases, a privilege exists that allows users holding the privilege to examine and process the contents of another user's inbox. This allows the organization to continue processing information, even when the user is unavailable.

Information stored in the system may be delivered to a user through several mechanisms.

Of course, the system provides its own mechanisms, as part of both the thick client and the thin client, to search for and retrieve information resources. The system allows searching based upon the subject and/or object, as well as the fields that exist in a selected information template. Keeping with the example from the previous section, it would be possible to search for an X-Ray, for the patient named Thomas Jones, taken at West Radiology.

A default interface may be provided that allows users to browse all records associated with a given subject. The user searches for the subject by providing all or part of a name or an identifying number (as defined by the organization). Once the desired subject is found, all records for that subject are shown, and the user can browse through the records and sort them in various ways in order to find a particular record.

The system may provide for exporting record metadata, along with links that point to each record, in a format suitable for use with a given third-party application. For example, it is possible to export patient records from the system in a format specified by a particular vendor of an Electronic Health Record (EHR) application. This format is unique to each vendor, and the system provides a program module to perform the necessary formatting for each supported third-party application.

A ‘link,’ in this case, may be a standard hyperlink, and/or a unique line of text. The operation of a hyperlink is well known and documented elsewhere; however, it is not always possible to open a web browser or client program, or otherwise click on a hyperlink, in the context of some third-party systems. The invention provides in one embodiment a unique string to identify each processed record, which can be embedded in a section of text (along with a unique prefix), to be made available to such an application. On a client computer where the thick client is installed, selecting this unique combination of text and copying it to the operating system clipboard triggers the thick client application and retrieves the record from the server, displaying it to the user. In this manner, information resources managed by the system can be made available to other applications, even in cases where the third-party application does not support the use of a standard hyperlink.

Because the server may utilize commonly used, open standard protocols and programmatic interfaces (such as HTTP and XML Web Services), information resources are continuously available to any third-party application that is also capable of utilizing these standards and protocols. The interface between such a third-party application and the server is effectively the same as the interface between a thick or thin client created by the server developer, and the server itself. Utilizing standards and well-known protocols allows the system to be immediately interoperable with other modern software applications

The system provides facilities for archiving information resources based on activity date (the last time the resource was used in any way), subject, or object. Archives produced by the system are self-describing and written in XML format, accompanied by the physical files that were originally processed into the system. All information and metadata remains properly associated in the archive. This means not only that the system can re-import its own archives without dependence on any other piece of data that may have been changed or removed since the archive was created; it also comprises a standard export format for third-party systems capable of parsing XML documents to make use of the archive in the exact same way.

In the preferred embodiment, the system does allow encryption and password-protection of archives for security purposes. In the event an archive is encrypted, the consuming application user must know the password to decrypt the archive in order to make use of it directly.

The system may record user activities associated with both processing and delivery of information resources. This user activity data forms the basis of built-in system reports, describing user activities and organizational efficiency in processing and utilizing information stored in the system. Because the system data upon which these reports are based is available via standard XML Web Service calls, other systems can take advantage of such activity data in a larger of different context (for example, an organization might choose to create personnel reports that include information stored outside the system—such as an employee number and working hours—as well as activity data kept within the system—such as how quickly, on average, a particular user processes records after introduction into their virtual inbox).

System Maintenance is comprised of maintenance activities on the Application Host Platform(s), the Storage Medium(s), and the Database, as well as infrequent but necessary options for maintaining subject records.

The system may provide basic capabilities for monitoring the overall health of the computer(s) hosting the various server components. Specifically, it is possible to monitor the congestion of network interfaces on these systems and throttle-back usage of the system when the network interfaces pass a user-defined activity threshold. It is also possible to monitor available disk space (both to the application's database and storage medium, and to the operating system root partitions hosting these server layers), and to throttle back or completely stop usage of the application after free disk space decreases below a set of user-defined low and critical thresholds. Additionally, the system can monitor host platforms to ensure that critical processes are running, and may be able to notify an administrative user in the event such processes stop running (although success is dependent upon which critical process fails to respond).

The system may automatically notify a given administrative contact when internal program errors are detected, to enable the administrator to respond to such problems, should they occur, as efficiently as possible.

As alluded to above, the system definition includes electronic contact information (electronic mail or a MODEM-dialed connection point, such as a pager or cell phone) to be used in case of critical failures and high-priority problems to alert the administrator of the condition.

The Storage Medium may be either a large disk/file system local to the server, or a large network file share dedicated to the purpose of housing data files for the server.

As previously noted, the system is preferred to actively monitor available disk space wherever possible to ensure that the server does not ‘crash’ if disk space becomes too low. Also, the system monitors its own access, and the potential access of others (specifically non-administrators) to the Storage Medium directly by checking permissions actively wherever possible. The administrator is alerted if permissions are known to allow an entity other than the system itself and a local administrative user to directly access files in the Storage Medium.

Most of the system metadata, and all active record metadata, is preferred to be stored in a database, which may be either local to the server or installed on another computer and accessed through vendor-specific protocols over the network.

Aside from monitoring general computer health on the database server layer host, as previously noted, the system may actively check the structure and sanity of the database tables and records that make up the meta-information store. If any inconsistency is detected, the administrator is immediately notified of the problem and specifically what error condition caused the notification.

From time to time, subject records will likely be deleted entirely, split, or combined with the records of a different subject. For example, in a technical support organization, one customer (company) may merge with another, requiring their entity records to be combined. The server provides facilities for associating records from one subject with another, one-by-one and en masse, as well as merging one subject's records to another (presumably authoritative or correct) subject. The user may choose to copy or actually move records in such a case, and may also choose whether to remove an entity from which no records exist after such an operation is completed.

In one embodiment, all users may collaboratively ensure the quality of records stored in the system. “All users” may be a large number of users, and more than two or three users. As mentioned in the section on Error! Reference source not found., it is possible for the system to export records and meta-information to an external/third-party system in a format suitable for that system to use. In cases where this capability is utilized, it is important to note that the transaction is generally one-way; information can be provided to the third-party system, but cannot generally be later removed from outside the application in question. Primarily for this reason, the system implements a cooperative arrangement for ensuring the quality of information published externally.

Under this arrangement, every information resource is assigned a unique string identifier to form part of the clipboard link as previously discussed. This string also identifies a status of the resource as one of four possible states: Exported, Confirmed, Misfiled, and Dead Link.

A record is considered Exported when it is ready to be consumed by a third-party application as noted above. In this state, if the clipboard link is clicked, the user will be warned that the information is not yet Confirmed, and that it should be treated as suspect until someone confirms that the record is correctly identified and filed.

While viewing an item so opened, the user is presented with the option of reporting that the record is correctly filed. While it is possible for the user who originally processed the record to confirm the record in bulk, this may not be feasible for all organizations. In this way, anyone who is trusted enough to be a system user can also share the burden of confirming that exported information shows up correctly.

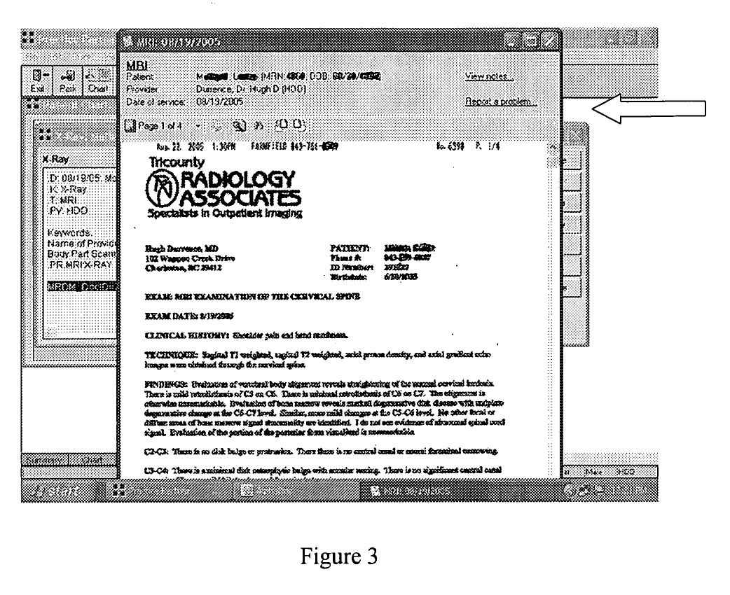

Another option to report a problem may be provided to a user viewing a record. FIG. 3. If a user chooses to report a problem, the system prompts to user to provide a small amount of detail as to the nature of the problem noted. Once this detail is provided, the status of the record is changed to Misfiled.

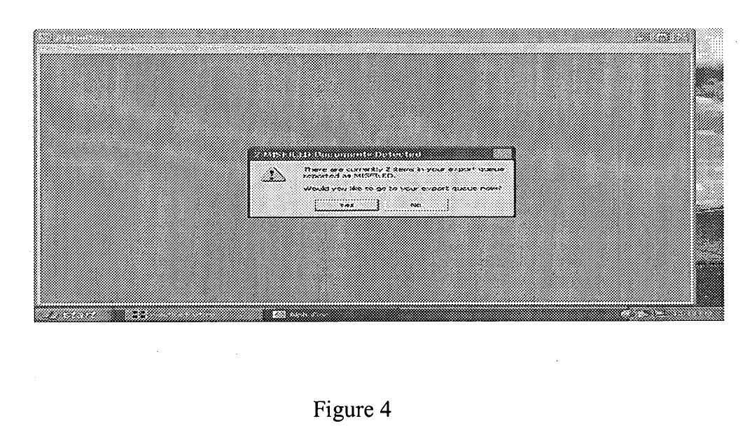

When a record is misfiled, the user who processed that record receives a warning from the system and is prompted to address the problem. FIG. 4.

The details provided by the reporting user are shared with the processing user. However, while reported as Misfiled, the record can still be viewed; the user viewing the record at this time will receive a warning and an indication of what, specifically, the reporting user noted as a problem in the report.

If the user who originally processed the record is not available, as previously noted, a privilege may exist that allows another user, so configured, to look into the unavailable user's queue and take ownership of the record in order to fix it.

In the event the problem reported is not found or is not valid, the user processing the record can simply return the record to Confirmed status.

This cycle of reporting a problem, responding to the problem, reconfirming the record (without changing the record in any way) may continue indefinitely. However, as soon as the processing user makes a change to the record, the record gets a new identifier. The record's status under the previous unique identifier becomes Dead Link—essentially meaning that this old record has been changed or removed (and, a user visiting a Dead Link will see an error message to this effect, and will NOT see the record in question). The status of the new identifier is set to Exported, and the process starts anew.

This process allows the option of all system users—not just those who process information initially—to share the burden of quality assurance. It also allows administrative or otherwise privileged users to step in when problems are not corrected in a timely or adequate manner. Finally, keeping the same record (as opposed to recreating or reprocessing the record) ensures that an audit trail exists, which mirrors each actual piece of information managed by the system, regardless of how many such cycles it goes through—thus, organizations can collect data and take steps to correct what might otherwise be an invisible problem.

What is claimed is:

1. A method of managing documents, comprising the steps of:
examining information contained in a document;
assigning particular data to said document as required by an information template record;
transferring said document to a server; and
retrieving said document from said server by copying at least some of said particular data to an operating system clipboard, wherein said particular data that is copied to said clipboard of said operating system is compared to said information contained in said document.

2. A method of managing documents as described in claim 1, further comprising the step of displaying said document after said document is retrieved from said server.

3. A method of managing documents as described in claim 1, further comprising the step of assigning an identifier to a link that is linked to said clipboard.

4. A method of managing documents as described in claim 1, wherein said document is available for retrieval to multiple users of said method, and wherein an error in said document is reportable to said server by each of said multiple users.

5. A method of managing documents as described in claim 1, further comprising the step of exporting said document and said particular data to an external server.

6. A method of managing documents as described in claim 5, wherein said document is retrieved from said eternal server by copying said particular data to said clipboard of said operating system.
